(19) United States
(12) Patent Application Publication
(10) Pub. No.: US 2023/0312784 A1
(43) Pub. Date: Oct. 5, 2023

(54) FUNCTIONALIZED HYDROGENATED POLYMERS

(71) Applicant: The Goodyear Tire & Rubber Company, Akron, OH (US)

(72) Inventors: Margaret Flook Vielhaber, Kent, OH (US); Thomas Franklin Spilker, Broadview Heights, OH (US)

(21) Appl. No.: 18/155,927

(22) Filed: Jan. 18, 2023

Related U.S. Application Data
(60) Provisional application No. 63/362,216, filed on Mar. 31, 2022.

(51) Int. Cl. C08F 136/14; C08K 3/36; B60C 1/00

(52) U.S. Cl. CPC C08F 136/14; C08K 3/36; B60C 1/0016

(57) ABSTRACT

A hydrogenated functionalized polymer obtained by selectively hydrogenating functionalized elastomer double bonds to a predetermined level of saturation, wherein the functionalized elastomer is a reaction product of a living elastomeric polymer and a polymerization terminator of formula I

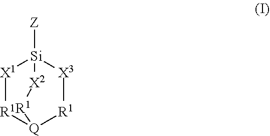

wherein R¹ is C1 to C4 linear alkyl, or C1 to C4 branched alkanediyl; X¹, X², X³ are independently O, S, or a group of formula (II) or (III)

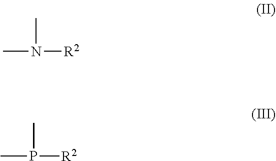

where R² is C1 to C18 linear or branched alkyl; Z is —R³—X⁴; R³ is C1 to C18 alkanediyl or dialkyl ether diyl; X⁴ is a group that is able to react with a pseudo-living chain end.

### FIELD OF THE INVENTION

The disclosure relates to functionalized rubbery polymers that are selectively saturated by hydrogenation. It is intended for use in rubber applications, such as for tires, and will be described with particular reference thereto. However, it is appreciated that the present exemplary embodiments are also amenable to other like applications.

### BACKGROUND OF THE INVENTION

Most rubber polymers are derived from a conjugated diene and contain unsaturation points along the hydrocarbon polymer chain for crosslinking. Over time, a cured rubber can suffer degradation caused by light, oxygen (ozone), and heat exposure. The ozone attacks double bonds in the rubber chains, thus accelerating aging. As aging occurs, physical properties change in the cured rubber product.

Additives, such as antiozonants, are widely used to protect rubber against ozone deterioration. To work effectively, they must possess characteristics that allow them to migrate to the rubber surface where they act as a barrier. Alternative approaches are desired in which an additive is not required. Thus, a saturated polymer is proposed to improve aging in cured rubber products.

However, a rubber compound must continue to perform to its desired specifications. Longevity cannot be improved to the detriment of performance. Using tires as an illustrative article, tread formulations that contain silica filler exhibit a number of important performance advantages over those that use carbon black. In tread formulations, the silica is believed to (a) lower rolling resistance, (b) provide better traction on snow, and (c) lower noise generation when compared with conventional tires filled with carbon black. Therefore, a polymer is desired that provides better aging while maintaining strong compatibility with silica filler.

### SUMMARY OF THE DISCLOSURE

The present disclosure provides a low-cost means for generating a polymer that can be incorporated in the manufacture of rubber products, such as tires, when better aging and performance is desired.

The present invention is directed to a hydrogenated functionalized polymer obtained by selectively hydrogenating functionalized elastomer double bonds to a predetermined level of saturation, wherein the functionalized elastomer is the reaction product of a living elastomeric polymer and a polymerization terminator of formula I,

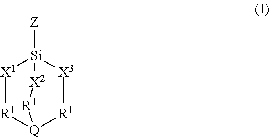

wherein R¹ is C1 to C4 linear alkyl, or C1 to C4 branched alkanediyl; X¹, X², X³ are independently O, S, or a group of formula (II) or (III)

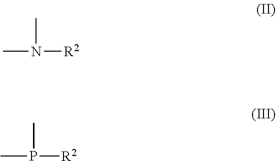

where R² is C1 to C18 linear or branched alkyl; Z is R³, —OR⁴, or —R^{5—}X⁴; R³, R⁴ are independently C1 to C18 linear or branched alkyl; R⁵ is C1 to C18 alkanediyl or dialkyl ether diyl; X4 is halogen or a group of structure IV or VIII

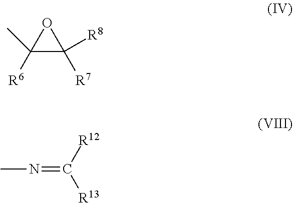

wherein R⁶, R⁷, R⁸ are independently H or C1 to C8 alkyl; R¹² and R¹³ are independently H, aryl or C1 to C8 alkyl;
Q is N or a group of structure IX

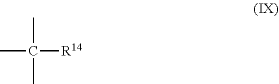

wherein R¹⁴ is C1 to C8 alkyl.

In one embodiment, the functionalized elastomer comprises repeat units of a diene monomer and optionally a vinyl aromatic monomer, and the functionalized elastomer comprises at least 92 percent by weight of cis 1,4 microstructure content based on the weight of the polydiene content of the functionalized elastomer.

The invention is further directed to a method of making the functionalized elastomer.

The invention is further directed to a rubber composition comprising the functionalized elastomer, and a pneumatic tire comprising the rubber composition.

### DETAILED DESCRIPTION OF THE INVENTION

The present disclosure is directed to a functionalized polymer that is produced by selectively hydrogenating a functionalized elastomer to generate a predetermined saturation level of the polymer. The hydrogenation of the functionalized elastomer can be performed using methods and catalysts known in the art and, more particularly, described infra. Particularly, in one embodiment the final polymer is obtained by hydrogenating double bonds in a functionalized elastomer versus being produced by functionalizing a saturated elastomer.

By “selective” hydrogenation, termination of the hydrogenation reaction is performed after either full or partial conversion of double bonds in the functionalized elastomer. In one embodiment, the hydrogenation is terminated when at least the polydiene portion of the functionalized elastomer is from about 10 percent to about 40 percent, or alternatively from 40 percent to about 80 percent, or alternatively from about 80 percent to about 100 percent, saturated by hydrogenation of the functionalized polymer. In one embodiment, the final polymer is fully saturated along at least the polydiene portion of the elastomer chain. In one embodiment, the hydrogenation is terminated when the polydiene portion and/or the functionalized portion are from about 10 percent to about 40 percent, or alternatively from 40 percent to about 80 percent, or alternatively from about 80 percent to about 100 percent, saturated by hydrogenation of the functionalized polymer.

In the contemplated embodiment, the hydrogenated functionalized polymer is obtained by hydrogenating a functionalized elastomer disclosed in commonly owned U.S. Pat. No. 9,790,289—the contents of which are fully incorporated herein. That patent discloses a functionalized elastomer comprising the reaction product of a living elastomeric polymer and a polymerization terminator of formula I, wherein the functionalized elastomer comprises repeat units of a diene monomer and optionally a vinyl aromatic monomer, and the functionalized elastomer comprises at least 92 percent by weight of cis 1,4 microstructure content based on the weight of the polydiene content of the functionalized elastomer

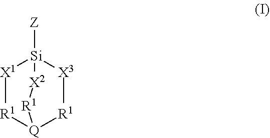

wherein R¹ is C1 to C4 linear alkyl, or C1 to C4 branched alkanediyl; X¹, X², X³ are independently O, S, or a group of formula (II) or (III)

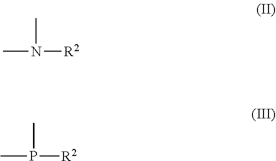

where R² is C1 to C18 linear or branched alkyl; Z is —R³—X⁴; R³ is C1 to C18 alkanediyl or dialkyl ether diyl; X⁴ a group of structure IV or V

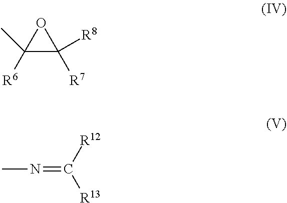

wherein R⁶, R⁷, R⁸, are independently H or C1 to C8 alkyl; R¹² and R¹³ are independently H, aryl or C1 to C8 alkyl;
Q is N or a group of structure IX

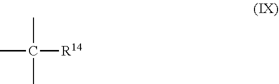

wherein R¹⁴ is C1 to C8 alkyl.

The hydrogenated functionalized polymer of this invention is obtained by selectively hydrogenating to a desired degree of saturation a functionalized elastomer. Before the hydrogenation, the elastomer is made via solution polymerization in the presence of a lanthanide-based polymerization catalyst. Suitable catalyst may include lanthanide catalysts based on cerium, praseodymium, neodymium, or gadolinium. In one embodiment, the lanthanide-based polymerization catalyst is neodymium catalyst system. Such polymerizations are typically conducted in a hydrocarbon solvent that can be one or more aromatic, paraffinic, or cycloparaffinic compounds. These solvents will normally contain from 4 to 10 carbon atoms per molecule and will be liquids under the conditions of the polymerization. Some representative examples of suitable organic solvents include pentane, isooctane, cyclohexane, normal hexane, benzene, toluene, xylene, ethylbenzene, and the like, alone or in admixture.

The neodymium catalyst system used in the process of this invention is made by preforming three catalyst components. These components are (1) an organoaluminum compound, (2) a neodymium carboxylate, and (3) a dialkyl aluminum chloride. In making the neodymium catalyst system the neodymium carboxylate and the organoaluminum compound are first reacted together for 10 minutes to 30 minutes in the presence of isoprene to produce a neodymium-aluminum catalyst component. The neodymium carboxylate and the organoaluminum compound are preferable reacted for 12 minutes to 30 minutes and are more preferable reacted for 15 to 25 minutes in producing the neodymium-aluminum catalyst component.

The neodymium-aluminum catalyst component is then reacted with the dialkyl aluminum chloride for a period of at least 30 minutes to produce the neodymium catalyst system. The activity of the neodymium catalyst system normally improves as the time allowed for this step is increased up to about 24 hours. Greater catalyst activity is not normally attained by increasing the aging time over 24 hours. However, the catalyst system can be aged for much longer time periods before being used without any detrimental results.

The neodymium catalyst system will typically be preformed at a temperature that is within the range of about 0° C. to about 100° C. The neodymium catalyst system will more typically be prepared at a temperature that is within the range of about 10° C. to about 60° C. The neodymium catalyst system will preferably be prepared at a temperature that is within the range of about 15° C. to about 30° C.

The organoaluminum compound contains at least one carbon to aluminum bond and can be represented by the structural formula:

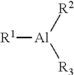

in which R¹ is selected from the group consisting of alkyl (including cycloalkyl), alkoxy, aryl, alkaryl, arylalkyl radicals and hydrogen: R² is selected from the group consisting of alkyl (including cycloalkyl), aryl, alkaryl, arylalkyl radicals and hydrogen and R³ is selected from a group consisting of alkyl (including cycloalkyl), aryl, alkaryl and arylalkyl radicals. Representative of the compounds corresponding to this definition are: diethylaluminum hydride, di-n-propylaluminum hydride, di-n-butylaluminum hydride, diisobutylaluminum hydride, di phenyl aluminum hydride, di-p-tolylaluminum hydride, dibenzylaluminum hydride, phenyl ethyl aluminum hydride, phenyl -n-propylaluminum hydride, p-tolyl ethylaluminum hydride, p-tolyl-n-propylaluminum hydride, p-tolylisopropylaluminum hydride, benzylethylaluminum hydride, benzyl-n-propylaluminum hydride, and benzylisopropylaluminum hydride and other organoaluminum hydrides. Also included are ethylaluminum dihydride, butylaluminum dihydride, isobutylaluminum dihydride, octylaluminum dihydride, amylaluminum dihydride and other organoaluminum dihydrides. Also included are diethylaluminum ethoxide and dipropylaluminum ethoxide. Also included are trim ethyl aluminum, tri ethyl aluminum, tri-n-propylaluminum, triisopropylaluminum, tri-n-propylaluminum, triisopropylaluminim, tri-n-butylaluminum, triisobutylaluminum, tripentylaluminum, trihexylaluminum, tricyclohexylaluminum, trioctylaluminum, triphenylaluminum, tri-p-tolylaluminum, tribenzylaluminum, ethyldiphenylaluminum, ethyl-di-p-tolylaluminum, ethyldibenzylaluminum, diethylphenylaluminum, diethyl-p-tolylaluminum, diethylbenzylaluminum and other triorganoaluminum compounds.

The neodymium carboxylate utilizes an organic monocarboxylic acid ligand that contains from 1 to 20 carbon atoms, such as acetic acid, propionic acid, valeric acid, hexanoic acid, 2-ethylhexanoic acid, neodecanoic acid, lauric acid, stearic acid and the like neodymium naphthenate, neodymium neodecanoate, neodymium octanoate, and other neodymium metal complexes with carboxylic acid containing ligands containing from 1 to 20 carbon atoms.

The proportions of the catalyst components utilized in making the neodymium catalyst system of this invention can be varied widely. The atomic ratio of the halide ion to the neodymium metal can vary from about 0.1/1 to about 6/1. A more preferred ratio is from about 0.5/1 to about 3.5/1 and the most preferred ratio is about 2/1. The molar ratio of the trialkylaluminum or alkylaluminum hydride to neodymium metal can range from about 4/1 to about 200/1 with the most preferred range being from about 8/1 to about 100/1. The molar ratio of isoprene to neodymium metal can range from about 0.2/1 to 3000/1 with the most preferred range being from about 5/1 to about 500/1.

The amount of catalyst used to initiate the polymerization can be varied over a wide range. Low concentrations of the catalyst system are normally desirable in order to minimize ash problems. It has been found that polymerizations will occur when the catalyst level of the neodymium metal varies between 0.05 and 1.0 millimole of neodymium metal per 100 grams of monomer. A preferred ratio is between 0.1 and 0.3 millimole of neodymium metal per 100 grams of monomer.

The concentration of the total catalyst system employed of course, depends upon factors such as purity of the system, polymerization rate desired, temperature and other factors. Therefore, specific concentrations cannot be set forth except to say that catalytic amounts are used.

Temperatures at which the polymerization reaction is carried out can be varied over a wide range. Usually the temperature can be varied from extremely low temperatures such as −60° C. up to high temperatures, such as 150° C. or higher. Thus, the temperature is not a critical factor of the invention. It is generally preferred, however, to conduct the reaction at a temperature in the range of from about 10° C. to about 90° C. The pressure at which the polymerization is carried out can also be varied over a wide range. The reaction can be conducted at atmospheric pressure or, if desired, it can be carried out at sub-atmospheric or super-atmospheric pressure. Generally, a satisfactory polymerization is obtained when the reaction is carried out at about autogenous pressure, developed by the reactants under the operating conditions used.

Many types of unsaturated monomers which contain carbon-carbon double bonds can be polymerized into polymers using such metal catalysts. Elastomeric or rubbery polymers can be synthesized by polymerizing diene monomers utilizing this type of metal initiator system. The diene monomers that can be polymerized into synthetic rubbery polymers can be either conjugated or nonconjugated diolefins. Conjugated diolefin monomers containing from 4 to 8 carbon atoms are generally preferred. Vinyl-substituted aromatic monomers can also be copolymerized with one or more diene monomers into rubbery polymers, for example styrene-butadiene rubber (SBR). Some representative examples of conjugated diene monomers that can be polymerized into rubbery polymers include 1,3-butadiene, isoprene, 1,3-pentadiene, 2,3-dimethyl-1,3-butadiene, 2-methyl1,3-pentadiene, 2,3-dimethyl-1,3-pentadiene, 2-phenyl-1,3-butadiene, and 4,5-diethyl-1,3-octadiene. Some representative examples of vinyl-substituted aromatic monomers that can be utilized in the synthesis of rubbery polymers include styrene, 1-vinylnapthalene, 3-methyl styrene, 3,5-diethyl styrene, 4-propyl styrene, 2,4,6-trimethylstyrene, 4-dodecylstyrene, 3-methyl-5-normal-hexyl styrene, 4-phenyl styrene, 2-ethyl-4-benzyl styrene, 3,5-diphenylstyrene, 2,3,4,5-tetraethyl styrene, 3-ethyl-l-vinylnapthalene, 6-isopropyl-1-vinylnapthalene, 6-cyclohexyl-1-vinylnapthalene, 7-dodecyl-2-vinylnapthalene, α-methylstyrene, and the like.

The rubbery polymers that are functionalized with a terminator of formula I in accordance with this invention are generally prepared by solution polymerizations that utilize inert organic solvents, such as saturated aliphatic hydrocarbons, aromatic hydrocarbons, or ethers. The solvents used in such solution polymerizations will normally contain from about 4 to about 10 carbon atoms per molecule and will be liquids under the conditions of the polymerization. Some representative examples of suitable organic solvents include pentane, isooctane, cyclohexane, normal-hexane, benzene, toluene, xylene, ethylbenzene, tetrahydrofuran, and the like, alone or in admixture. For instance, the solvent can be a mixture of different hexane isomers. Such solution polymerizations result in the formation of a polymer cement (a highly viscous solution of the polymer).

The metal terminated living rubbery polymers utilized in the practice of this invention can be of virtually any molecular weight. However, the number average molecular weight of the living rubbery polymer will typically be within the range of about 50,000 to about 500,000. It is more typical for such living rubbery polymers to have number average molecular weights within the range of 100,000 to 250,000.

The metal terminated living rubbery polymer can be functionalized by simply adding a stoichiometric amount of a terminator of formula Ito a solution of the rubbery polymer (a rubber cement of the living polymer). In other words, approximately one mole of the terminator of formula I is added per mole of terminal metal groups in the living rubbery polymer. The number of moles of metal end groups in such polymers is assumed to be the number of moles of the metal utilized in the initiator. It is, of course, possible to add greater than a stoichiometric amount of the terminator of formula I. However, the utilization of greater amounts is not beneficial to final polymer properties. Nevertheless, in many cases it will be desirable to utilize a slight excess of the terminator of formula Ito insure that at least a stoichiometric amount is actually employed or to control the stoichiometry of the functionalization reaction. In most cases from about 0.8 to about 1.1 moles of the terminator of formula I will be utilized per mole of metal end groups in the living polymer being treated. In the event that it is not desired to functionalize all of the metal terminated chain ends in a rubbery polymer then, of course, lesser amounts of the terminator of formula I can be utilized.

The terminator of formula I will react with the metal terminated living rubbery polymer over a very wide temperature range. For practical reasons the functionalization of such living rubbery polymers will normally be carried out at a temperature within the range of 0° C. to 150° C. In order to increase reaction rates, in most cases it will be preferred to utilize a temperature within the range of 20° C. to 100° C. with temperatures within the range of 50° C. to 80° C. being most preferred. The capping reaction is very rapid and only very short reaction times within the range of 0.5 to 4 hours are normally required. However, in some cases reaction times of up to about 24 hours may be employed to insure maximum conversions.

In one embodiment, the terminator of formula I has one of the structures shown in Table 1.

TABLE 1

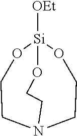 [SMILES: CCO[Si]12OCCN(CCO1)CCO2]

ESTE

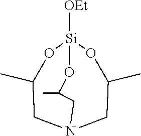

ESTI

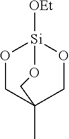

ESTM

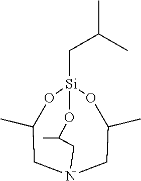

BSTI

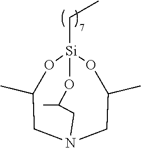

OSTI

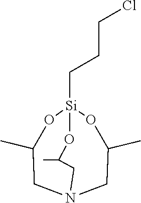

CSTI

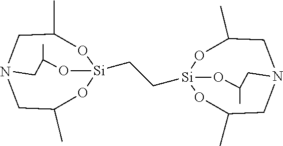 [SMILES: CC1CN2CC(C)O[Si](CC[Si]34OC(C)CN(CC(C)O3)CC(C)O4)(O1)OC(C)C2]

BIPOS

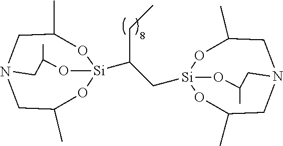

BIDECS

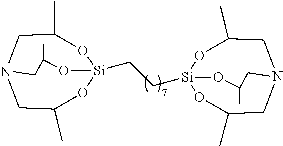

BIOCTS

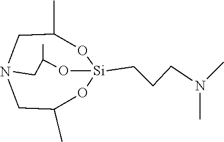 [SMILES: CC1CN2CC(C)O[Si](CCCN(C)C)(O1)OC(C)C2]

DMASTI

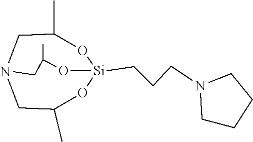 [SMILES: CC1CN2CC(C)O[Si](CCCN3CCCC3)(O1)OC(C)C2]

PYSTI

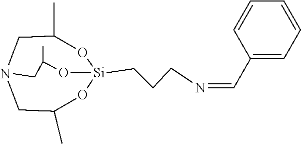 [SMILES: CC1CN2CC(C)O[Si](CCC/N=C\c3ccccc3)(O1)OC(C)C2]

BIMSTI

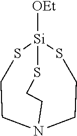 [SMILES: CCO[Si]12SCCN(CCS1)CCS2]

ETTS

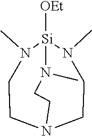

ETAS

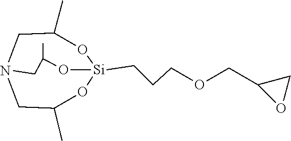 [SMILES: CC1CN2CC(C)O[Si](CCCOCC3CO3)(O1)OC(C)C2]

EPTI
ESTE: 1-ethoxy-2,8,9-trioxa-5-aza-1-silabicyclo[3.3.3]undecane, or ethoxysilatrane
ESTI: 1-ethoxy-3,7,10-trimethyl-2,8,9-trioxa-5-aza-1-silabicyclo[3.3.3]undecane, or 1-
ethoxy-3,7,10-trimethylsilatrane
ESTM: 1-ethoxy-4-methyl-2,6,7-trioxa-1-silabicyclo[2.2.2]octane
BSTI: 1-isobutyl-3,7,10-trimethyl-2,8,9-trioxa-5-aza-1-silabicyclo[3.3.3]undecane, or 1-
isobutyl-3,7,10-trimethylsilatrane
OSTI: 1-octyl-3,7,10-trimethyl-2,8,9-trioxa-5-aza-1-silabicyclo[3.3.3]undecane, or 1-
octyl-3,7,10-trimethylsilatrane
CSTI: 1-(3-chloropropyl)-3,7,10-trimethyl-2,8,9-trioxa-5-aza-1-
silabicyclo[3.3.3]undecane, or 1-(3-chloropropyl)-3,7,10-trimethylsilatrane
BIPOS: 1,2-bis(3,7,10-trimethyl-2,8,9-trioxa-5-aza-1-silabicyclo[3.3.3]undecan-1-
yl)ethane, or 1,2-bis(3,7,10-trimethylsilatrane)ethane
BIDECS: 1,1′-(decane-1,2-diyl)bis(3,7,10-trimethyl-2,8,9-trioxa-5-aza-1-
silabicyclo[3.3.3]undecane), or 1,1′-(decane-1,2-diyl)bis(3,7,10-trimethylsilatrane)
BIOCTS: 1,8-bis(3,7,10-trimethyl-2,8,9-trioxa-5-aza-1-silabicyclo[3.3.3]undecan-1-
yl)octane, or 1,8-bis(3,7,10-trimethylsilatrane)octane
DMASTI: N,N-dimethyl-3-(3,7,10-trimethyl-2,8,9-trioxa-5-aza-1-
silabicyclo[3.3.3]undecan-1-yl)propan-1-amine
PYSTI: 3,7,10-trimethyl-1-(3-(pyrrolidin-1-yl)propyl)-2,8,9-trioxa-5-aza-1-
silabicyclo[3.3.3]undecane
BIMSTI: N-benzylidene-3-(3,7,10-trimethyl-2,8,9-trioxa-5-aza-1-
silabicyclo[3.3.3]undecan-1-yl)propan-1-amine
ETTS: 1-ethoxy-2,8,9-trithia-5-aza-1-silabicyclo[3.3.3]undecane; or 1-ethoxy-
thiosilitrane
ETAS: 1-ethoxy-2,8,9-trimethyl-2,5,8,9-tetraaza-1-silabicyclo[3.3.3]undecane; or 1-
ethoxy-2,8,9-triazasilatrane
EPTI: 3,7,10-trimethyl-1-(3-(oxiran-2-ylmethoxy)propyl)-2,8,9-trioxa-5-aza-1-
silabicyclo[3.3.3]undecane; or 1-(3-(oxiran-2-ylmethoxy)propyl)- 3,7,10-
trimethylsilatrane

The functionalized elastomer may then undergo a hydrogenation reaction to selectively saturate the functionalized elastomer to a desired level. By this reaction, a select amount of double bonds in at least the polydiene rubber portion are converted to single bonds. This reduces the number of unsaturation points that are susceptible to ozone degradation in the final polymer, thus improving aging. The hydrogenation reaction is selectively terminated after full or partial conversion of the double bonds in the polymer.

After the functionalization reaction is completed, it will normally be desirable to “kill” any living polydiene chains which remain. This can be accomplished by adding an alcohol, such as methanol or ethanol, to the polymer cement after the functionalization reaction is completed in order to eliminate any living polymer that was not consumed by the reaction with the terminator of formula I. The end-group functionalized polydiene rubber can then be recovered from the solution utilizing standard techniques.

The hydrogenated functionalized polymer may be incorporated in a variety of rubber articles including, but not limited to, components for a tire, coated metal, coated wire, coated cord, hoses, belts, and shoe soles. For example, a rubber tire component may be a tread (including tread cap and tread base), sidewall, apex, chafer, sidewall insert, wirecoat or innerliner. In one embodiment, the component is a tread. In a tread, the disclosed hydrogenated functionalized polymer has better aging and may be used to maintain or improve performance, via an improved polymer-filler interaction among other things. Using tire tread compounds as an illustrative example, the disclosed hydrogenated functionalized polymer may result in improved traction and rolling resistance—the latter being a result of reduced hysteresis. For illustrative examples, a tire rubber is described.

The functionalized polymer may be compounded into a rubber composition.

The rubber composition may optionally include, in addition to the functionalized polymer, one or more rubbers or elastomers containing olefinic unsaturation. The phrases “rubber or elastomer containing olefinic unsaturation” or “diene based elastomer” are intended to include both natural rubber and its various raw and reclaim forms as well as various synthetic rubbers. In the description of this invention, the terms “rubber” and “elastomer” may be used interchangeably, unless otherwise prescribed. The terms “rubber composition,” “compounded rubber” and “rubber compound” are used interchangeably to refer to rubber which has been blended or mixed with various ingredients and materials and such terms are well known to those having skill in the rubber mixing or rubber compounding art. Representative synthetic polymers are the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter are acetylenes, for example, vinyl acetylene; olefins, for example, isobutylene, which copolymerizes with isoprene to form butyl rubber; vinyl compounds, for example, acrylic acid, acrylonitrile (which polymerize with butadiene to form NBR), methacrylic acid and styrene, the latter compound polymerizing with butadiene to form SBR, as well as vinyl esters and various unsaturated aldehydes, ketones and ethers, e.g., acrolein, methyl isopropenyl ketone and vinylethyl ether. Specific examples of synthetic rubbers include neoprene (polychloroprene), polybutadiene (including cis-1,4-polybutadiene), polyisoprene (including cis-1,4-polyisoprene), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate, as well as ethylene/propylene terpolymers, also known as ethylene/propylene/diene monomer (EPDM), and in particular, ethylene/propylene/dicyclopentadiene terpolymers. Additional examples of rubbers which may be used include alkoxy-silyl end functionalized solution polymerized polymers (SBR, PBR, IBR and SIBR), silicon-coupled and tin-coupled star-branched polymers. The preferred rubber or elastomers are polyisoprene (natural or synthetic), polybutadiene and SBR.

In one aspect the at least one additional rubber is preferably of at least two of diene based rubbers. For example, a combination of two or more rubbers is preferred such as cis 1,4-polyisoprene rubber (natural or synthetic, although natural is preferred), 3,4-polyisoprene rubber, styrene/isoprene/butadiene rubber, emulsion and solution polymerization derived styrene/butadiene rubbers, cis 1,4-polybutadiene rubbers and emulsion polymerization prepared butadiene/acrylonitrile copolymers.

In one aspect of this invention, an emulsion polymerization derived styrene/butadiene (E-SBR) might be used having a relatively conventional styrene content of about 20 to about 28 percent bound styrene or, for some applications, an E-SBR having a medium to relatively high bound styrene content, namely, a bound styrene content of about 30 to about 45 percent.

By emulsion polymerization prepared E-SBR, it is meant that styrene and 1,3-butadiene are copolymerized as an aqueous emulsion. Such are well known to those skilled in such art. The bound styrene content can vary, for example, from about 5 to about 50 percent. In one aspect, the E-SBR may also contain acrylonitrile to form a terpolymer rubber, as E-SBAR, in amounts, for example, of about 2 to about 30 weight percent bound acrylonitrile in the terpolymer.

Emulsion polymerization prepared styrene/butadiene/acrylonitrile copolymer rubbers containing about 2 to about 40 weight percent bound acrylonitrile in the copolymer are also contemplated as diene based rubbers for use in this invention.

The solution polymerization prepared SBR (S-SBR) typically has a bound styrene content in a range of about 5 to about 50, preferably about 9 to about 36, percent. The S-SBR can be conveniently prepared, for example, by organo lithium catalyzation in the presence of an organic hydrocarbon solvent.

In one embodiment, cis 1,4-polybutadiene rubber (BR) may be used. Such BR can be prepared, for example, by organic solution polymerization of 1,3-butadiene. The BR may be conveniently characterized, for example, by having at least a 90 percent cis 1,4-content.

The cis 1,4-polyisoprene and cis 1,4-polyisoprene natural rubber are well known to those having skill in the rubber art.

The term “phr” as used herein, and according to conventional practice, refers to “parts by weight of a respective material per 100 parts by weight of rubber, or elastomer.”

The rubber composition may also include up to 70 phr of processing oil. Processing oil may be included in the rubber composition as extending oil typically used to extend elastomers. Processing oil may also be included in the rubber composition by addition of the oil directly during rubber compounding. The processing oil used may include both extending oil present in the elastomers, and process oil added during compounding. Suitable process oils include various oils as are known in the art, including aromatic, paraffinic, naphthenic, vegetable oils, and low PCA oils, such as IVIES, TDAE, SRAE and heavy naphthenic oils. Suitable low PCA oils include those having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom.

The rubber composition may include from about 10 to about 165 phr of silica. In another embodiment, from 20 to 80 phr of silica may be used.

The commonly employed siliceous pigments which may be used in the rubber compound include conventional pyrogenic and precipitated siliceous pigments (silica). In one embodiment, precipitated silica is used. The conventional siliceous pigments employed in this invention are precipitated silicas such as, for example, those obtained by the acidification of a soluble silicate, e.g., sodium silicate.

Such conventional silicas might be characterized, for example, by having a BET surface area, as measured using nitrogen gas. In one embodiment, the BET surface area may be in the range of about 40 to about 600 square meters per gram. In another embodiment, the BET surface area may be in a range of about 80 to about 300 square meters per gram. The BET method of measuring surface area is described in the Journal of the American Chemical Society, Volume 60, Page 304 (1930).

The conventional silica may also be characterized by having a dibutylphthalate (DBP) absorption value in a range of about 100 to about 400, alternatively about 150 to about 300.

The conventional silica might be expected to have an average ultimate particle size, for example, in the range of 0.01 to 0.05 micron as determined by the electron microscope, although the silica particles may be even smaller, or possibly larger, in size.

Various commercially available silicas may be used, such as, only for example herein, and without limitation, silicas commercially available from PPG Industries under the Hi-Sil trademark with designations 210, 243, etc; silicas available from Rhodia, with, for example, designations of Z1165MP and Z165GR and silicas available from Degussa AG with, for example, designations VN2 and VN3, etc.

Commonly employed carbon blacks can be used as a conventional filler in an amount ranging from 10 to 150 phr. In another embodiment, from 20 to 80 phr of carbon black may be used. Representative examples of such carbon blacks include N110, N121, N134, N220, N231, N234, N242, N293, N299, N315, N326, N330, N332, N339, N343, N347, N351, N358, N375, N539, N550, N582, N630, N642, N650, N683, N754, N762, N765, N774, N787, N907, N908, N990 and N991. These carbon blacks have iodine absorptions ranging from 9 to 145 g/kg and DBP number ranging from 34 to 150 cm³/100 g.

Other fillers may be used in the rubber composition including, but not limited to, particulate fillers including ultra high molecular weight polyethylene (UHMWPE), crosslinked particulate polymer gels including but not limited to those disclosed in U.S. Pat. Nos. 6,242,534; 6,207,757; 6,133,364; 6,372,857; 5,395,891; or 6,127,488, and plasticized starch composite filler including but not limited to that disclosed in U.S. Pat. No. 5,672,639. Such other fillers may be used in an amount ranging from 1 to 30 phr.

In one embodiment the rubber composition may contain a conventional sulfur containing organosilicon compound. In one embodiment, the sulfur containing organosilicon compounds are the 3,3′-bis(trimethoxy or triethoxy silylpropyl) polysulfides. In one embodiment, the sulfur containing organosilicon compounds are 3,3′-bis(triethoxysilylpropyl) disulfide and/or 3,3′-bis(triethoxysilylpropyl) tetrasulfide.

In another embodiment, suitable sulfur containing organosilicon compounds include compounds disclosed in U.S. Pat. No. 6,608,125. In one embodiment, the sulfur containing organosilicon compounds includes 3-(octanoylthio)-1-propyltriethoxysilane, CH₃(CH₂)₆C(═O)—S—CH₂CH₂CH₂Si(OCH₂CH₃)₃, which is available commercially as NXT™ from Momentive Performance Materials.

In another embodiment, suitable sulfur containing organosilicon compounds include those disclosed in U.S. Patent Publication No. 2003/0130535. In one embodiment, the sulfur containing organosilicon compound is Si-363 from Degussa.

The amount of the sulfur containing organosilicon compound in a rubber composition will vary depending on the level of other additives that are used. Generally speaking, the amount of the compound will range from 0.5 to 20 phr. In one embodiment, the amount will range from 1 to 10 phr.

It is readily understood by those having skill in the art that the rubber composition would be compounded by methods generally known in the rubber compounding art, such as mixing the various sulfur-vulcanizable constituent rubbers with various commonly used additive materials such as, for example, sulfur donors, curing aids, such as activators and retarders and processing additives, such as oils, resins including tackifying resins and plasticizers, fillers, pigments, fatty acid, zinc oxide, waxes, antioxidants and antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. In one embodiment, the sulfur-vulcanizing agent is elemental sulfur. The sulfur-vulcanizing agent may be used in an amount ranging from 0.5 to 8 phr, alternatively with a range of from 1.5 to 6 phr. Up to 60 phr resin(s) can be used. Typical amounts of tackifier resins, if used, comprise about 0.5 to about 10 phr, usually about 1 to about 5 phr. Typical amounts of processing aids comprise about 1 to about 50 phr. Typical amounts of antioxidants comprise about 1 to about 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants comprise about 1 to 5 phr. Typical amounts of fatty acids, if used, which can include stearic acid comprise about 0.5 to about 3 phr. Typical amounts of zinc oxide comprise about 2 to about 5 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

Accelerators are used to control the time and/or temperature required for vulcanization and to improve the properties of the vulcanizate. In one embodiment, a single accelerator system may be used, i.e., primary accelerator. The primary accelerator(s) may be used in total amounts ranging from about 0.5 to about 4, alternatively about 0.8 to about 1.5, phr. In another embodiment, combinations of a primary and a secondary accelerator might be used with the secondary accelerator being used in smaller amounts, such as from about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. In one embodiment, the primary accelerator is a sulfenamide. If a second accelerator is used, the secondary accelerator may be a guanidine, dithiocarbamate or thiuram compound.

The mixing of the rubber composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions, and the volume and nature of the components. For example, the thermomechanical working may be from 1 to 20 minutes.

The rubber composition may be incorporated in a variety of rubber components of the tire. For example, the rubber component may be a tread (including tread cap and tread base), sidewall, apex, chafer, sidewall insert, wirecoat or innerliner. In one embodiment, the component is a tread.

The pneumatic tire of the present invention may be a race tire, passenger tire, aircraft tire, agricultural, earthmover, off-the-road, truck tire, and the like. In one embodiment, the tire is a passenger or truck tire. The tire may also be a radial or bias.

Vulcanization of the pneumatic tire of the present invention is generally carried out at conventional temperatures ranging from about 100° C. to 200° C. In one embodiment, the vulcanization is conducted at temperatures ranging from about 110° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A hydrogenated functionalized polymer obtained by selectively hydrogenating functionalized elastomer double bonds to a predetermined level of saturation, wherein the functionalized elastomer is a reaction product of a living elastomeric polymer and a polymerization terminator of formula I, wherein the functionalized elastomer comprises repeat units of a diene monomer and optionally a vinyl aromatic monomer, and the functionalized elastomer comprises at least 92 percent by weight of cis 1,4 microstructure content based on the weight of the polydiene content of the functionalized elastomer 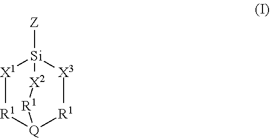
wherein R¹ is C1 to C4 linear alkyl, or C1 to C4 branched alkanediyl; X¹, X², X³ are independently O, S, or a group of formula (II) or (III) 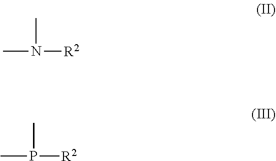
where R² is C1 to C18 linear or branched alkyl; Z is —R³—X⁴; R³ is C1 to C18 alkanediyl or dialkyl ether diyl; X⁴ is a group of structure IV or V 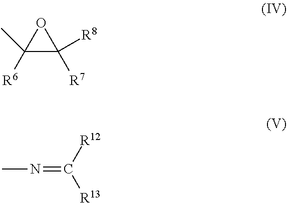
wherein R⁶, R⁷, and R⁸are independently H or C1 to C8 alkyl; R¹² and R¹³ are independently H, aryl or C1 to C8 alkyl;
Q is N or a group of structure IX
wherein R¹⁴ is C1 to C8 alkyl.

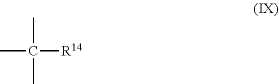

2. The hydrogenated functionalized polymer of claim 1, wherein the living elastomer is derived from at least one of isoprene and butadiene.

3. The hydrogenated functionalized polymer of claim 1, wherein the living elastomer is derived from butadiene.

4. The hydrogenated functionalized polymer of claim 1, wherein the polymerization terminator of formula I is selected from the group consisting of the following structures 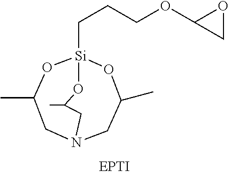 [SMILES: CC1CN2CC(C)O[Si](CCCOC3CO3)(O1)OC(C)C2]
EPTI: 3,7,10-trimethyl-1-(3-(oxiran-2-ylmethoxy)propyl)-2,8,9-trioxa-5-aza-1-silabicyclo[3.3.3]undecane; or 1-(3-(oxiran-2-ylmethoxy)propyl)-3,7,10-trimethylsilatrane.

5. The hydrogenated functionalized polymer of claim 1, wherein the functionalized elastomer comprises at least 95 percent by weight of cis 1,4 microstructure content based on the weight of the polydiene content of the functionalized elastomer.

6. The hydrogenated functionalized polymer of claim 1, wherein the functionalized elastomer comprises at least 98 percent by weight of cis 1,4 microstructure content based on the weight of the polydiene content of the functionalized elastomer.

7. A rubber composition comprising the hydrogenated functionalized polymer of claim 1.

8. The rubber composition of claim 7, further comprising silica.

9. A pneumatic tire comprising the rubber composition of claim 8.

10. The hydrogenated functionalized polymer of claim 1, wherein the living elastomeric polymer is polymerized in the presence of a lathanide-based coordination polymerization catalyst.

11. The hydrogenated functionalized polymer of claim 1, wherein the lanthanide-based coordination polymerization catalyst is a neodymium based catalyst.

12. The hydrogenated functionalized polymer of claim 1, wherein the functionalized elastomer has a degree of hydrogenation of double bonds from about 10 percent to about 40 percent.

13. The hydrogenated functionalized polymer of claim 1, wherein the functionalized elastomer has a degree of hydrogenation of double bonds from about 40 percent to about 80 percent.

14. The hydrogenated functionalized polymer of claim 1, wherein the functionalized elastomer has a degree of hydrogenation of double bonds from about 80 percent to about 100 percent.

15. The hydrogenated functionalized polymer of claim 1, wherein the functionalized elastomer is fully saturated.
